(19) United States
(12) Patent Application Publication
(10) Pub. No.: US 2007/0249447 A1
(43) Pub. Date: Oct. 25, 2007

(54) Synchronous belt sprocket

(76) Inventor: James B. Wilson, Cross, SC (US)

Correspondence Address: Jeffrey Thurnau;The Gates Corporation, IP Law Dept. 10-A3, 1551 Wewatta Street, Denver, CO, 80202, US

(21) Appl. No.: 11/392,368

(22) Filed: Mar. 29, 2006

(51) Int. Cl. F16H 55/30; F16H 7/00

(52) U.S. Cl. 474/152; 474/153; 474/149

(57) ABSTRACT

A synchronous belt sprocket comprising a segment having a toothed profile, a member having an arcuate outer surface, the segment having a length substantially less than a total circumference of the outer surface, and at least two segments fixed to the outer surface oriented for the toothed profile to apply a tangential force from a belt to the outer surface.

### FIELD OF THE INVENTION

The invention relates to a synchronous belt sprocket, and more particularly to a synchronous belt sprocket comprising a toothed segment attached to a cylindrical member, the segment having a length substantially less than a total circumference of the outer surface.

### BACKGROUND OF THE INVENTION

Sprockets comprise a plurality of teeth that are arranged in alternating fashion with groves. The teeth and grooves extend about an entire outer circumference of the sprocket. A toothed belt engages the toothed surface. Cost as well as physical constraints such as diameter or weight effectively limit the upper size for toothed sprockets, in particular for low torque applications.

Representative of the art is U.S. Pat. No. 5,322,478 (1994) to Bos et al. which discloses a divisible sprocket wheel, made from synthetic material, comprising two wheel halves with axial planes abutting against each other and means for interconnecting the wheel halves, consisting of two interconnected parts made from synthetic material, each part made by means of injection molding and comprising a radial inner side face, a radial outer side face and a circumferential face, the two parts of said wheel half abutting against each other through their radial inner side faces, each part further comprising cavities and ribs as determined by the injection molding process extending at least in part from the inner side face to the outer side face from each part, these cavities and ribs being located inside said wheel half when the two parts that form said wheel half are abutting, said wheel half having a radial outer side face which is essentially flat.

What is needed is a synchronous belt sprocket comprising a toothed segment attached to a cylindrical member, the segment having a length substantially less than a total circumference of the outer surface. The invention meets this need.

### SUMMARY OF THE INVENTION

The primary aspect of the invention is to provide a synchronous belt sprocket comprising a toothed segment attached to a cylindrical member, the segment having a length substantially less than a total circumference of the outer surface.

Other aspects of the invention will be pointed out or made obvious by the following description of the invention and the accompanying drawings.

The invention comprises a synchronous belt sprocket comprising a segment having a toothed profile, a member having an arcuate outer surface, the segment having a length substantially less than a total circumference of the outer surface, and at least two segments fixed to the outer surface oriented for the toothed profile to apply a tangential force from a belt to the outer surface.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a plan view of a sprocket tooth segment.

FIG. 2 is a side view of a sprocket tooth segment.

FIG. 3 is a side view of the inventive synchronous belt sprocket with toothed segment.

FIG. 4 is an axial view of the sprocket in FIG. 3.

### DETAILED DESCRIPTION OF THE PREFERRED EMBODIMENT

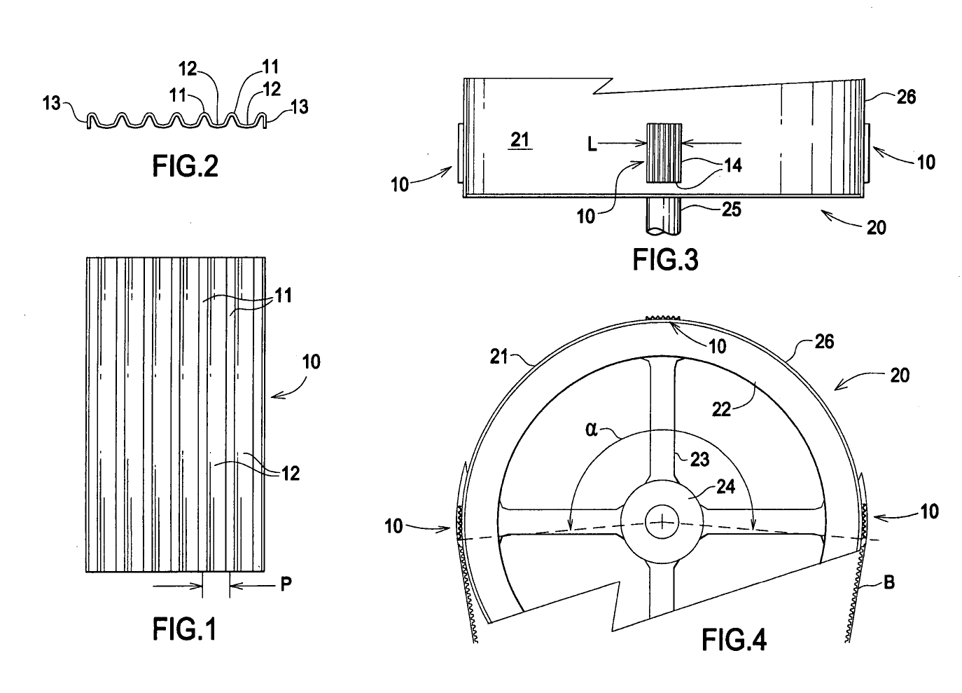

The inventive sprocket comprises a synchronous belt sprocket comprising a toothed segment attached to a cylindrical member. FIG. 1 is a plan view of a sprocket tooth segment. Segment 10 comprises alternating teeth 11 and grooves 12. Segment 10 is made of any suitably rigid material that can be adhered to a mounting surface. The preferred segment material is metallic such as aluminum or steel, although other materials may be used as well, including ceramic, phenolic or urethane. Each segment can be stamped, machined or molded depending upon the material using methods known in the art.

The pitch P between adjacent teeth 11 is designed to substantially match the pitch of a toothed belt that will engage the segment. The segment should minimally comprise at least three teeth and two grooves.

FIG. 2 is a side view of a sprocket tooth segment. Each outer edge of the segment comprises a reinforcement member 13 which serves to maintain the shape of the outer tooth on each edge of the segment as well as providing a means of securing the segment to a cylindrical member, see FIG. 3. The profile of each tooth is selected to substantially match any of the known profiles for toothed synchronous belts.

FIG. 3 is a side view of the inventive synchronous belt sprocket with toothed segment. Cylindrical member 21 may comprise rolled sheet metal or prefabricated cylindrical sections, including large diameter pipe or conduit. The cylindrical member 21 may also comprise non-metallic material such as plastic.

Segments 10 are attached to outer surface 26 oriented so the toothed profile will apply a tangential force from a belt B to the outer surface, thereby driving the sprocket. This requires that the teeth extend substantially parallel to an axis of rotation, namely, parallel to a drive shaft 25. In the case of a metal segment, welds 14 are applied sufficient to resist tear out by the tangential shear force. The means of attaching the segment to the outer surface 26 can also include screwing, rivets, keys, glue as well as any other method known in the art.

In order to assure proper indexing of the belt to the cylindrical member, a sufficient number of segments must be fixed to the outer surface 26 so that at least two segments are always in contact with the belt. Therefore, the number of segments will be determined by the angle of wrap of the belt on the sprocket.

The length L of each segment 10 is substantially less than a total circumference of the arcuate outer surface. For example, in the case of an 8 mm pitch (P), the length L is:
3×8=24 mm

Of course, longer segments may be used as well.

FIG. 4 is an axial view of the sprocket in FIG. 3. Sprocket 20 comprises a rim 22 and spokes 23. Spokes 23 are connected to rim 22 and radiate from hub 24. Hub 24 engages a drive shaft 25. Belt B is engaged with segments 10 and outer surface 26. Outer surface 26 between segments is generally not toothed.

In an alternate embodiment the outer surface between each segment may be omitted or the outer surface 26 would be discontinuous. The portion of the member to which the segment 10 is mounted would then comprise only a portion of the arcuate outer surface. An omitted or untoothed outer surface 26 between segments 10 does not contribute to transmitting a tangential force to the sprocket in a substantial manner.

Further, the sprocket need not rotate through 360° on shaft 25, instead, it might only oscillate through an arc of a predetermined length, for example, approximately 90°.

The angle of wrap α is approximately 185°. The number of segments 10 shown in this embodiment is four. However, three segments would work as well since the angle of wrap would cause at least two of the three segments to be engaged with the belt at all times, assuming they are spaced equally.

In the alternate embodiment where the sprocket only oscillates through an angular range the sprocket may only require a single segment.

Although forms of the invention have been described herein, it will be obvious to those skilled in the art that variations may be made in the construction and relation of parts without departing from the spirit and scope of the inventions described herein.

I claim:

1. A synchronous belt sprocket comprising:
a segment having a toothed profile;
a member having an arcuate outer surface;
the segment having a length substantially less than a total circumference of the outer surface; and
at least two segments fixed to the outer surface oriented for the toothed profile to apply a tangential force from a belt to the outer surface.

2. The synchronous belt sprocket as in claim 1 further comprising a hub for engaging a shaft.

3. The synchronous belt sprocket as in claim 1, wherein each segment comprises at least three teeth.

4. The synchronous belt sprocket as in claim 1, wherein the member comprises a cylindrical form.
